(19) United States
(12) Patent Application Publication
(10) Pub. No.: US 2002/0143960 A1
(43) Pub. Date: Oct. 3, 2002

(54) Virtual network generation system and method

(76) Inventors: Erez Goren, Rishpon (IL); Eyal Salomon, Ashdod (IL); Yoram Haas, Kadima (IL)

Correspondence Address: Toby H. Kusmer, McDermott, Will & Emery, 28 State Street, Boston, MA, 02109, US

(21) Appl. No.: 09/729,395

(22) Filed: Dec. 4, 2000

Related U.S. Application Data
(60) Provisional application No. 60/222,519, filed on Aug. 2, 2000.

(51) Int. Cl. G06F 15/16

(52) U.S. Cl. 709/229; 709/228

(57) ABSTRACT

A virtual network generation system facilitates the dynamic establishment, maintenance and dissolution of private network communities (PNCs), which may include extended communication links between isolated and geographically dispersed wired and/or wireless electronic devices, as if the electronic devices were set in their own LAN. The virtual network generation system takes advantage of existing communication infrastructure, such as the Internet, Wide Area Networks (WANs), power-lines, telephone lines, and cable networks, and uses them as shared backbones providing dynamic PNC links. Electronic devices connected to the dynamic private network become virtual nodes relating to different PNCs.

### CROSS REFERENCES TO RELATED APPLICATIONS

This application claims the benefit of priority from commonly owned U.S. Provisional Patent Application Serial No. 60/222,519, entitled Virtual Network Generation System and Method, filed Aug. 2, 2000.

### FIELD OF THE INVENTION

The present invention relates generally to systems and methods used in the communications between isolated and geographically dispersed wired and/or wireless electronic devices. More specifically, the invention is directed to systems and methods for the establishment of on demand private networks of clients capable of sharing resources within the context of commonly available and potentially disparate networks.

### BACKGROUND OF THE INVENTION

The proliferation of large network infrastructures and backbones has facilitated abundant and inexpensive bandwidth availability to consumers. In order to illustrate the exponential improvement in bandwidth capacity, one can point out the fact that not very long ago, 128K ISDN line were introduced by telephone companies, asymmetric digital subscriber line (ADSL) or high speed digital subscriber line (HDSL) 768Kbps-6Mbps were being offered as new means of connecting offices and homes. Furthermore in the near future, cable modems are expected to provide a downstream bandwidth of 10-36Mbps, greater than a traditional 10 BaseT network, for fairly cheap monthly fees. The trend is definitely moving away from considering bandwidth as a scarce resource, similar to the evolution of the attitude towards memory usage and on-line/off-line storage capacity. The most well known example of a large public network backbone is the Internet, but other communications carriers include cable, broadband wireless networks, and Metropolitan Area Networks (MAN), are also examples. Increasing connectivity between consumers, organizations and service providers, through the different communication channels, is about to transform the information and data transfer environment as a whole and the landscape of network connectivity services in particular.

While bandwidth capacity increases, there remains a need to focus the access to include sharing information and resources, depending on the application or use for which the access is required. That is, electronic devices can increasingly access different types of information for completely unrelated tasks. For example, a household personal computer can be used in the morning for working (from the home) in a virtual office environment, at noon to shop for merchandise in the local department store, in the afternoon to exchange essays relating to homework given at the local school, and in the evening to play network-enabled computer games.

In an organizational setting, typical network communication technology allows for pre-determined connections between users via means such as a standard local area network (LAN) or wide area network (WAN) (collectively, LAN/WAN) to any group of users (private or commercial) connected to a dedicated infrastructure. The most important feature making LAN like networks unique is it's inherent broadcasting capabilities. These network communications enable the users to share the same resources (e.g., printers, files, and so on), security mechanisms, and access to all nodes on the designated infrastructure, as defined by the network administrator and/or system manager. In addition, all communications in the LAN/WAN are managed and handled through a central mediator, e.g., a network server, which facilitates the connection. At present, network communication providers deliver services by setting up potential users with accounts on their servers, thus compelling users to communicate via their sites and having access to a fixed set of users. The problem with the current approach is that it requires all potential users to share the same communication channels, in addition to a common set of network attributes, such as adhering to the same communication protocols, security privileges or schemes, and access to the same resources, generally. As such, only devices in which provisions for the traditional LAN/WAN attributes have been laid can be connected to the network. Furthermore, other than passive devices like printers, the devices which can be connected to the network usually share similar computing characteristics, such as all being personal computers.

At the same time, with the growth in use of the Internet, network enabled functionality is becoming increasingly portable. For example, personal digital assistants (PDAs), such as the Palm™ handhelds (by Palm, Inc. of Santa Clara, Calif.) can be used to read electronic mail from a service provider and receive information downloaded from the Internet and World Wide Web (the “Web”), depending on the configuration and the subscribed to services. Additionally, such portable devices can then transfer data to a high-quality printer in a nearby print shop, in one scenario. Other similar portable, network enabled devices are increasingly available, most with some degree of Internet access.

As with LANs/WANs within organizations, network communications for Internet-based consumers, such as Web-based chat groups, on-line video games or electronic mail services provided by Internet service providers (ISPs), is limited. For instance, while Internet users have less restrictions on the users with which they can interact, they have no real capacity for defining closed workgroups and sharing typical LAN-like resources (e.g., printers, CPU, files) and services (e.g., backup, security, service spoolers).

Intrinsically, in each of these typical networks there is no provision for a user node to set up a temporary LAN like network for a specific task, and related sub-tasks, which enables the execution of the task and then disassemble itself upon completion. An example can be a set of programmers working in their respective homes on a common software project, each needing to access common files from each other or from a protected software repository in a central location.

To attempt to link remote users set outside the shared LAN infrastructure, some service providers offer “virtual private networks” (VPNs). In a typical VPN, a node or a network is connected to another network, i.e., a node-to-network link or network-to-network link. In such a case, a network is always needed on one of the sides. That is, in the VPN solution a remote node is placed on a network segment that includes a device to be included in the VPN, as if that remote host (or client) is physically there on the network. However, as an example, if several remote users each has a Windows™ (from Microsoft Corporation, Redmond, Wash.) configured personal computer (PC) at home, with no network behind any of them, e.g., just an Internet connection, the users can not be linked in a VPN, since none of them is on a network.

It is an object of the present invention to provide a system and method for establishing private communities of potentially disparate electronic devices over potentially disparate, communication channels and then, preferably, to selectively disestablish the communities, wherein such a private community may be configured to allow shared resources and network attributes, found more traditionally in LAN/WAN environments having a dedicated, private infrastructure.

### SUMMARY OF THE INVENTION

The present invention is a virtual network generation (VNG) system and method for establishing and managing private network communities (PNCs) including, potentially, a plurality of isolated and geographically dispersed electronic devices (or “clients”) coupled together over extended and potentially disparate communication links. A PNC in accordance with the present invention allows use of any transport framework, including publicly available frameworks, as a backbone to selectively establish secure or unsecured links, thereby extending communications between otherwise isolated clients. PNCs may be selectively assembled, disassembled, reassembled, joined, disjoined, and rejoined. A PNC is, preferably, setup and controlled automatically, dynamically and remotely by a PNC control system, which has the ability to route through public networks in a manner that enables substantially similar security and functionality available in traditional private networks, such as a LAN. From the perspective of the end-user at a client, the nature of the physical network through which information is routed is irrelevant. The PNC appears to the end-user as a traditional, dedicated private network that emulates a natural, familiar and standard LAN workflow.

The prerequisite elements for setting up a PNC include the VNG system, an existing backbone communication infrastructure, and a plurality of clients. A client may be any of a variety of wired or wireless devices, such as a PC, PDA, cellular telephone, pager, portable e-mail device, Web-enabled television or appliance, an application running on a server, or any other of a number of similar networked devices running any available operating system (e.g., Windows™ 98, MAC™ OS (by Apple Computer, Inc. of Cupertino, Calif.), Palm™ OS, and so on). Communication protocols and links used by the clients may take any standard form, including telephone, satellite, and computer networks. Networks in the present invention may include LANs, WANs, MANs, private networks, public networks, secure or unsecured networks, the Internet, the Web or some combination thereof.

The VNG system preferably includes a front-end interface for provisioning, management and control accessible by clients, such as a Web site interface or a native client application or a combination of the two, and at least one back-end VNG application system having one or more VNG servers and databases. The network interface may be run on a typical front end Web server (or servers). The functional components of the VNG system include a core suite of functionality (or functional managers) that may be run on the VNG server(s) and a client module that may be run on each client. Through accessing the network server interface, the functionality of the VNG system is made available to a user attempting to setup or join a PNC.

The client module includes functionality for facilitating communication within the PNC with other PNC workgroup members. A network interface emulation module is responsible for the network emulation achieved by mimicking the existence of a standard network segment environment and includes a virtual network interface card (NIC) driver, a communication service or driver and, optionally, a host bus or intermediate driver. The virtual NIC driver includes functionality for grabbing outgoing packets sent down from the client hosts network interface system and for injecting incoming packets back up into that same system. Packets grabbed are then passed on, wrapped, and transmitted. Packets received are unwrapped and injected into the system. In one form, the virtual NIC driver allows a standard modem to behave like a network card within the context of a LAN-like PNC. In another form the virtual driver allows for the short-circuiting of a virtual NIC output and input with the backbone access accessory (be it a modem or any other internal or external card).

The communication service or driver includes functionality that encapsulates a standard network protocol frame native to the given electronic device as a payload/data of a PNC defined wrapper frame. The wrapper frame is prepared in accordance with standard message protocols (e.g., UDP, TCP/IP), such that it can traverse any intermediate transit backbones, such as Internet, cables, or telephone. The network emulation subsystem is separated into incoming and outgoing directions. The outgoing part includes the functionality for grabbing, compressing, encrypting, wrapping the data packet in a secure frame that can traverse the public transit backbone and finally transmitting it. The incoming part includes the receiving, validating, unwrapping, decrypting, decompressing, and finally injecting the data packet into the receiving host network stack (for example, an IP stack), as would any standard LAN driver.

A communication service module generates messages to be transmitted in response to client activity and passes incoming messages to a virtual NIC driver. . The communication service module is generally responsible for the receiving and transmitting of all network data to and from the client host over the communications backbone.

The core functionality hosted by the VNG server(s) may include several modules necessary for establishing and managing each PNC, authenticating users, managing security keys, switching/routing PNC traffic, terminating PNCs, logging usage, and (optionally) billing users. For example, a registration and authentication manager may be included to facilitate the recording of membership in a VNG database, later used for authentication of PNC workgroup members and enabling PNC creation. A switching/routing manager routes data packet traffic that may also include packet wrapper frame reformatting (for example TCP/IP to UDP and visa versa, UDP to HTTP and visa versa, and so on) and general processing. A security manager is also provided to implement the chosen security mechanisms and levels, such as private public key encryption. A billing, or account, manager may be included to perform usage-based monitoring and the generation of corresponding invoices therefrom, and potentially electronic fund transfers to pay such invoices. Alternatively, logging of usage may be performed by a PNC manager, which may act like a PNC session manager to coordinate the other managers and resources. As will be appreciated by those skilled in the art, the foregoing functionality may be distributed among a variety of types of resources and the managers identified herein are merely used for illustrative purposes.

In accordance with the present invention, a method of establishing one or more PNCs among isolated and geographically dispersed electronic devices over existing communication infrastructure is provided. This is accomplished by taking advantage of existing communication infrastructure, such as the Internet, power-lines, telephone lines, and cable networks, and using them as shared backbones facilitating private network links. The links can be established between various electronic devices (or clients), such as personal computers, intelligent appliances, smart home video games or scarce resources such as high-quality color laser printers. The private networks can be set up after an initial registration phase, which may require a client module be downloaded and installed on each of the clients to be included in the PNC, as a PNC workgroup. Subsequently, creation of a PNC is based on a list of addresses representing all clients in the workgroup; the PNC workgroup membership may be a function of a set of tasks to be accomplished. In the preferred embodiment, the PNCs include sets of server-managed tunnels encapsulating data within special communication protocol packets to transport information that does not otherwise conform to any public network addressing standards. The end result is that all users, i.e., clients connected to the network, become virtual nodes relating to different dynamic communities that they created or of which they are members.

In accordance with the present invention, a technique for establishing PNCs between disparate electronic devices over existing communication channels includes the steps:

1) registering on the VNG system Web site,

2) connecting to the VNG server and establishing the identity of each member of a PNC workgroup, defining security management and other communication attributes,

3) forming a connection by the VNG server to a VNG system database, which holds all information related to different users and networks it manages,

4) receiving authorization or authentication for PNC workgroup members,

5) performing address resolution by assigning a unique address within the PNC for each corresponding client (i.e., member) and generating a PNC having the requisite security management and communication attributes, as a LAN-like environment,

6) utilizing network functionality available on the PNC by PNC workgroup members, as if connected via a network card to a LAN in order to perform a set of tasks, and

7) disassembling the PNC upon a termination event, such as completion of the set of tasks.

Note that unlike LANs, one does not require prior setup of special communication hardware and software for the establishment of a PNC. On the contrary, in the present invention, only access to any shared backbone or communication medium is necessary. All that is required of the user is to load the client module, which facilitates connection to a PNC by providing certain communication functionality to the client. The client module can be downloaded from the VNG system network (e.g., the VNG system Web site). A user may be required to initially register and subsequently authenticate, via the Web interface, with the VNG system prior to being enabled to create or join a PNC. From that point on, the setup of a PNC is accomplished upon demand, with as many clients as required, and potentially for a prescribed set of tasks. The PNC then imitates a LAN-like environment with the added value of dynamic membership according to task requirements, faster speed, added security, while requiring no dedicated infrastructure among or between the various clients.

### BRIEF DESCRIPTION OF THE DRAWINGS

The foregoing and other objects of the invention, the various features thereof, as well as the invention itself, may be more fully understood from the following description, when read together with the accompanying drawings of which:

FIG. 1A is a network diagram of a typical prior art LAN architecture;

FIG. 1B is a network diagram of a representative PNC architecture;

FIG. 1C is a block diagram of an exemplary VNG system configuration, in accordance with the present invention, for generating and managing the PNC of FIG. 1B;

FIG. 2 is a diagram of a database system that may be used by the VNG system of FIG.

FIG. 3 is a block diagram of an embodiment of a PNC software architecture, in accordance with VNG system of FIG. 1C;

FIG. 4 is a diagram depicting network emulation components of a client module, in accordance with the present invention;

FIG. 5A is a diagram of a sample switch server link protocol header definition, in accordance with the present invention;

FIG. 5B is a table depicting a sample protocol definition implemented, in accordance with the present invention;

FIG. 5C is a diagram depicting a dynamic protocol stack implemented by a PNC client, in accordance with the present invention;

FIG. 6 is a flow diagram depicting a method of establishing and terminating a PNC with the VNG system of FIG. 1C;

FIG. 7A is a network diagram of a PNC in a mesh topology;

FIG. 7B is a network diagram of a PNC in a star topology;

FIGS. 8A-8C are diagrams depicting the interactions of various PNC clients, operating in different communication modes;

FIG. 9A is a network diagram depicting a PNC server in a stand alone configuration;

FIG. 9B is a network diagram depicting a PNC server in a dial-up configuration;

FIG. 9C is a network diagram depicting a PNC server in a “LAN add on” no firewall configuration;

FIG. 9D is a network diagram depicting a PNC server in a “LAN add on” DMZ configuration; and

FIG. 9E is a network diagram depicting a PNC server in a “LAN add on” inside firewall configuration.

### DETAILED DESCRIPTION OF THE INVENTION

The present invention is a VNG system and method for the establishment of one or more PNCs. A PNC may be comprised of different types of electronic devices (or clients) coupled together over existing, and potentially disparate, communication channels. In such a PNC, each client becomes a virtual node in a dynamic network shared by all PNC users. In accordance with the present invention, an established PNC dynamically emulates a complete private network environment, such as a standard LAN, to a group of clients (private or commercial) having access to a shared, though not inherently dedicated, infrastructure. Accordingly, a group of users, operating respective clients, can work within a PNC as if they are interconnected via a private network server, e.g., a LAN server, without actually having one at their disposal. As a consequence, all network-enabled applications available to the clients become Internet enabled when added to a PNC, in the case of an Internet backbone, or wide area enabled, in the case of other specific backbones, with the same benefits enjoyed by traditional private networks. As one example, PNC technology can be viewed as being similar to a telephone conference call enabler for computer based devices, incorporating the same flexibility, ease of use, availability and “Do It Yourself” (DIY) characteristics of registering, setting up and using standard telephone conference call utilities.

In contrast with traditional LANs, which allow only pre-determined connections between users (private or commercial) connected to a dedicated shared infrastructure, the VNG system enables the dynamic establishment of one or more PNC network segments and the sharing of all resources available to the connected users. Preferably, each PNC may define a domain comprised of a group of users having a common emphasis. For example, a PNC may be established among a group of users collaborating to accomplish a given set of tasks. PNCs can be disassembled (or terminated) upon request and re-assembled again at a later time. PNCs may also be terminated automatically in response to detection of a predetermined type of termination event, such as expiration of a timer, completion of tasks or a security violation.

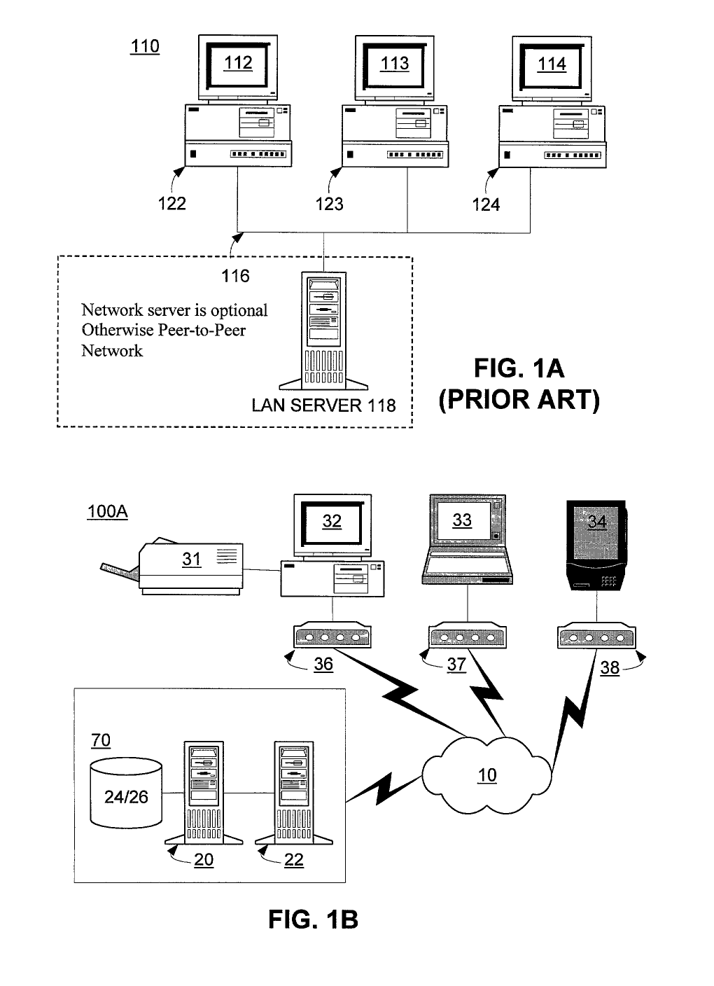

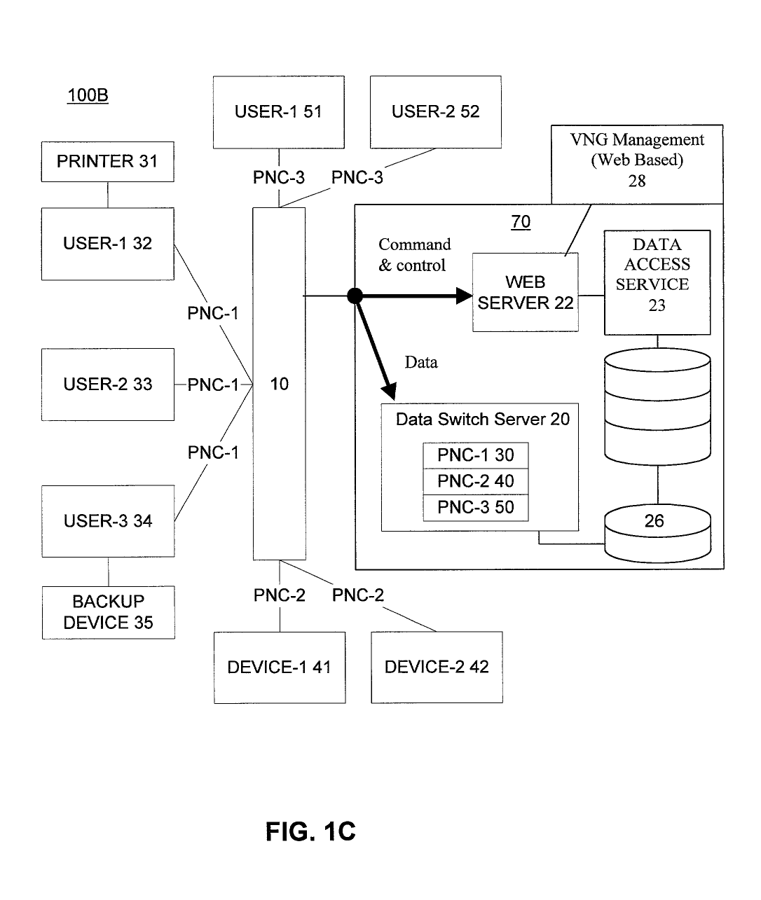

The differences between a typical prior art LAN architecture and a PNC architecture in accordance with the present invention can be appreciated with regard to prior art FIG. 1A and FIG. 1B, respectively. LAN architecture 110 of prior art FIG. 1A includes a group of personal computers 112, 113 and 114 connected to a LAN 116 under the control of LAN server 118. Although, optionally, the prior art architecture of FIG. 1A could be a peer-to-peer network, i.e., the architecture could be server-less. In FIG. 1A, each personal computer is interfaced to LAN 116 via a network card or unit, i.e., network interface cards (NIC) 122, 123, and 124. Therefore, there is a dedicated, relatively permanent LAN established for a given set of users that is not shared by non-LAN users. In contrast, in FIG. 1B a PNC 100A, for example PNC-1 of FIG. 1C, includes clients 32, 33 and 34 interconnected via a shared public backbone, represented by a network cloud 10. Also interfaced to backbone 10 is VNG system 70, which facilitates the establishment of the PNC and subsequent control and termination thereof. In FIG. 1B, VNG system 70 is shown with a data switch server 20, databases (DBs) 24/26, and a VNG Web server 22. Although, the use of two separate host servers is optional, that is, more or less servers could be used.

In the preferred form, each client includes a client module that causes each modem, or any other backbone connection apparatus, (e.g., modems 36, 37 and 38) to masquerade as a virtual NIC by providing a LAN-like interface to shared backbone 10. Each virtual NIC facilitates data transfer across the PNC by “short-circuiting” the LAN output/input to that of the modem. By “short-circuiting” it is meant that a virtual NIC acts as a “packet frame grabber”, wherein each LAN protocol frame is grabbed and then encapsulated as the payload of a wrapper frame that can traverse the shared backbone 10. As will be discussed in more detail below, each frame, preferably, is wrapped at an originating client and transmitted across backbone 10 to a destination client, where it is unwrapped and processed. The VNG system 70 provides all of the network management (e.g., identification, authentication, routing, addressing, security, end-to-end management, policy management, and so on) and the ability to tunnel through publicly available networks. From the host node perspective, the nature of the physical network being tunneled through is irrelevant, because it appears as if the information is being sent over a dedicated secure private network.

The following analogy can be made between the familiar LAN world and a VNG system PNC solution:

| Network Function | PNC | LAN |
|---|---|---|
| LAN Connection | Modem or any other | Network Interface Card |
| H/W | backbone access interface | |
| | card | |
| Connection & | 1) Service provider's | 1) Wall network socket |
| Wiring | Point Of Presence (POP) | |
| | 2) Backbone infrastructure | 2) Physical wiring, hubs, |
| | | switches, routers |
| Network | PNC server | 1) None - in the case of a |
| Management | | Peer-to-Peer Network, or |
| | | 2) In-house network |
| | | server |

Moving LAN workgroup related advantages to the subscriber level allows any group(s) of users and devices to collaborate, share resources and gain access to each other in an easy, geographically independent, simple, secure and cost effective manner. The VNG system does not merely provide a host device with a node-to-network link, but rather supplies the network environment itself. PNC workgroups are actually clusters of secure tunnels managed by, preferably, a central server (i.e., PNC data packet switch server 20) connecting the different nodes to form different virtual network segments (i.e., PNCS). Each PNC is setup and controlled automatically, dynamically, and remotely by a PNC server, according to the policy dictated by a network creator node (e.g., User-1 32).

To form a PNC, the VNG system can partition any backbone network infrastructure, such as the Internet, local telephone exchange, or a network of personal computers, into smaller private sub-networks referred to as “connection loops”, which provide secure, fast and reliable communications. As a result, large network infrastructures can be segmented into smaller, secure, centrally governed and automatically managed sub-networks using common client technology, wherein a PNC client module is downloaded to a client from a VNG server to enable the client as a PNC mode. The existence of each PNC is unknown to the users of other PNCs and non-PNCs sharing the communications infrastructure.

A plurality of PNCs, including VNG system 70, is shown in the network diagram 100B of FIG. 1C. Preferably, the VNG system 70 includes at least one VNG data packet switch server 20, a central data storage device 24, a web server 22 hosting a web site, a middle tear data access and security management device 23 and a run time in memory data repository 26. As will be appreciated by those skilled in the art, more or less servers and data storage devices may be used and, if pluralities of servers and data storage devices are used, they may be physically co-located or remote to each other. VNG system 70 is accessible by a plurality of electronic devices over a commonly available shared backbone 10. The communication links that provide access by the clients to VNG system 70 may include satellite, telephone, cable, as examples, or other known types of communication links. The electronic devices (or clients) may include any known network enabled wired or wireless devices, such as personal computers, pagers, cellular telephones, personal digital assistants, peripheral devices, application servers, and so on.

Data storage device 24 includes a system database 24A for holding system information, such as all user, workgroup, and network attributes, general control information, log data, and billing information. In the preferred form, data storage device 24 also includes the central data behind all the PNC server's operational logic, serving as the data repository for all of the PNC server building blocks (e.g. the provisioning web server device 22, the data packet switch server device 20 and the data access and security management service 23). An account database 24B stores account, registration and billing information related to the users. A run time in memory data repository 26 is available for the VNG's data switch server 20 holding information related to the real time data packet switching (workgroup configuration and attributes, clients states, etc).

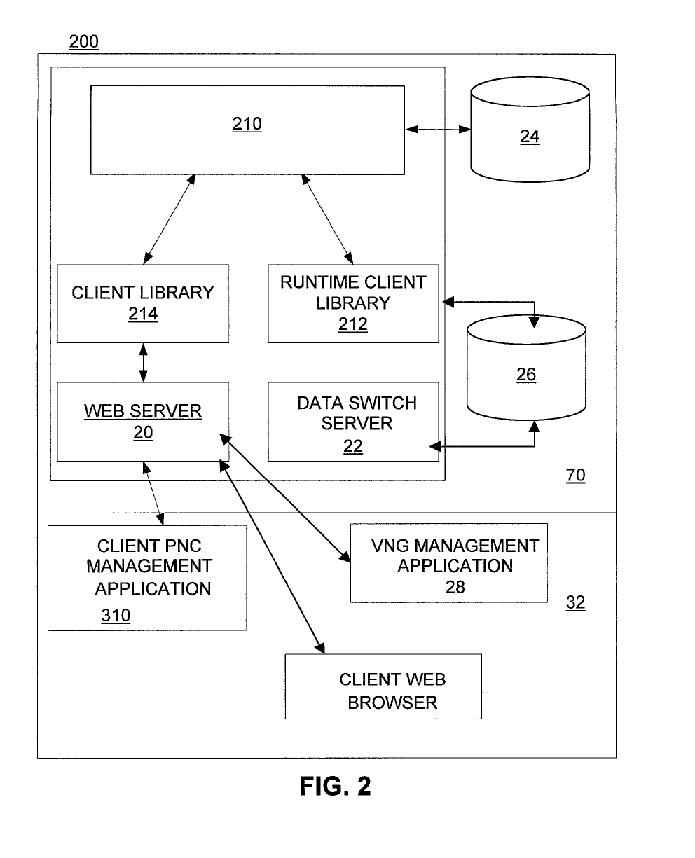

The PNC database system 200 is comprised of the following components, see FIG. 2:

1) Database engine 210: a commercial or freeware database platform such as: Oracle™, Sybase™, or Microsoft SQL Server, MySQL

2) Runtime client library 212: a middle-tier high performance interface set to connect the the database engine 210 with the run time in memory data repository used by the data switch server 22

3) Web services client library 214: a middle-tier interface set to connect the Web presentation layer and the database engine 210

The PNC database system 200 supports the following major functionality:

1) User registration

2) Private Network/Workgroup data storage and management

3) User usage tracking

4) Workgroup management

5) Active workgroup data storage and management

6) General administration data storage and management

Returning to FIG. 1C, three different PNCs are shown simultaneously and independently in existence. A first PNC, i.e., PNC-1, includes User 1 client 32 (and printer 31), User 2 client 33, and User 3 client 34 (and backup device 35) interconnected via shared backbone 10, under the control of VNG system 70, as indicated by PNC-1 session 30. Similarly, PNC-2 is comprised of client Device 1 41 and client Device 2 42 interconnected over backbone 10 and having a session 40 on VNG data packet switch server 20. Finally, PNC-3 includes User 1 client 51 and User 2 client 52 interconnected over backbone 10 and having a session 50 on VNG data packet switch server 20. PNC-1, PNC-2, and PNC-3, while operating generally over the same shared backbone 10, maintain independent virtual PNCs, each having its own designated workgroup membership, resources, and security constraints. Clients connected to the same virtual workgroup (after authentication, authorization and initial handshaking) may transfer data directly between each other or use the services of the VNG data packet switch server device for mediating (in cases were direct access is not available or for broadcast packets).

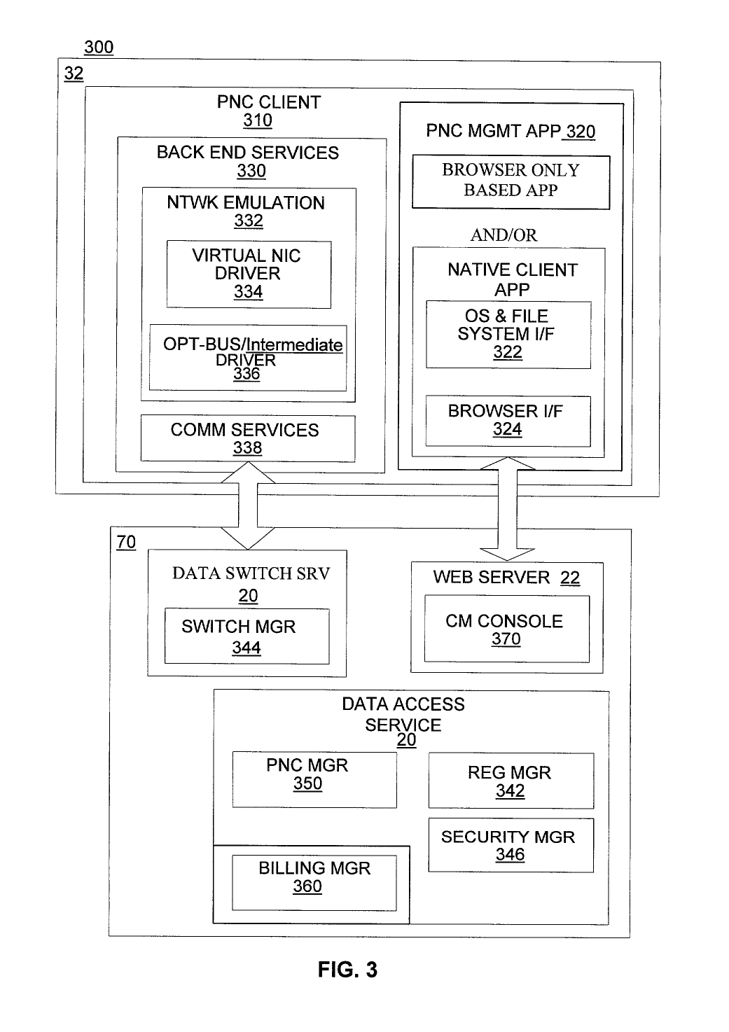

In the preferred form, a VNG suite of functional modules is used to deliver the VNG system functionality. This functionality may be implemented in software, hardware, firmware or some combination thereof. The preferred form of the VNG functional architecture 300 is shown in FIG. 3. Preferably, each client includes a client module 310 that integrates and runs with the other standard applications on a typical electronic device. For example, a typical electronic device includes a standard operating system (OS), such as Windows 95™, Windows 98™, Windows NT™, Windows CE™, Palm OS, Mac OS, and so on. Client module 310 is configurable for execution on any of these, or similar, electronic devices.

The basic functionality list of the PNC client 310 includes:

1) Workgroup:

a) Create (Name, Server, Sharing profile, Members, Roles)

b) Remove (Name, ID)

c) List (Name, ID, Priority <High Normal Low>, Number of online users).

2) User:

a) Find/Add/Delete/Block-User

b) Change Role (Administrator, Standard, Guest, Spectator)

c) User Status (Available, Away, Not Available, Do Not Disturb, Privacy, Offline)

d) User Details (Name, Nick Name, Addresses, E-Mail)

3) Communication:

a) Send Message

b) Receive message

c) Message history

4) Sharing Policy:

a) Set/Change/Reset Policy

5) Preferences:

a) Default Workgroup

b) Default Server

c) Default Initial User Status

d) Security Level

6) General:

a) Invitation Wizard

b) Address book/“Yellow Pages”

c) Add/Remove/List Servers

d) Set/Change/Save Preferences

e) Change User Identity

f) View Log and Alerts

g) Help

h) Exit-Sleep/Auto start/Shutdown

The PNC client module 310 includes a PNC client management module 320. The PNC client management module 320 is a graphical user interface (GUI) based application responsible for facilitating the user-level interactions required by the VNG system generated environment. The PNC client management module 320 is set as either a browser-only based interface or a hybrid interface of a browser and a native host application.

As a hybrid interface, the client management module 320 includes a local host OS and file system dependant interface module 322 that allows the client module 310 to operate within the framework of the client device, by allowing the client module 310 to take advantage of the standard services available from the OS and file system of the client (i.e., change sharing profile). A client-based Graphical User Interface (GUI) browser interface module 324 is also included and is responsible for facilitating all user-level command and control interactions with the VNG web server 22 (i.e., set-up, manage, logon/off, register, monitor, change attributes, invite new workgroup members, etc.). For example, browser interface module 324 provides an interface (e.g., as a plug-in) to a standard client Web browser (e.g., Internet Explorer™ by Microsoft Corporation) for facilitating user friendly access to PNC functionality, thereby enabling browser-based user registration, PNC creation, management, monitoring, log viewing and (optionally) billing. As a browser-only interface, the PNC client management module 320 does not include the O.S. dependant extended functionality (i.e., module 322), but rather only includes the browser interface module 324, which supplies the basic command and control functionality set through a standard web browser (e.g. Internet Explorer™ by Microsoft Corporation, Netscape Navigator™ by Netscape Communications Corporation of Mountain View, Calif.).

In the preferred embodiment, PNC client management module 320 exposes a dual functionality scheme:

1) Server side—Interacting with a selected VNG server for registration, set up, manipulation and management of each PNC. The communications with the VNG server is based on standard Web interface (i.e., HTTP protocol). The functionality is common to both types of applications browser only and native application.

2) Client specific side—Interacting with the local host environment (e.g., Win98, Win2000, etc.). The scope of functionality exported is limited to the boundaries set by the underlying operating system and file system (for example, support for file level security attributes, user level security, file sharing, changing sharing profiles, etc.).

The client module 310 also includes a backend service module 330. In the preferred form, the backend service module 330 includes a network emulation module 332 and a communication service module 338. Together, modules 332 and 338 allow the client to connect with and interact over a PNC (either with the VNG server and or directly with other clients).

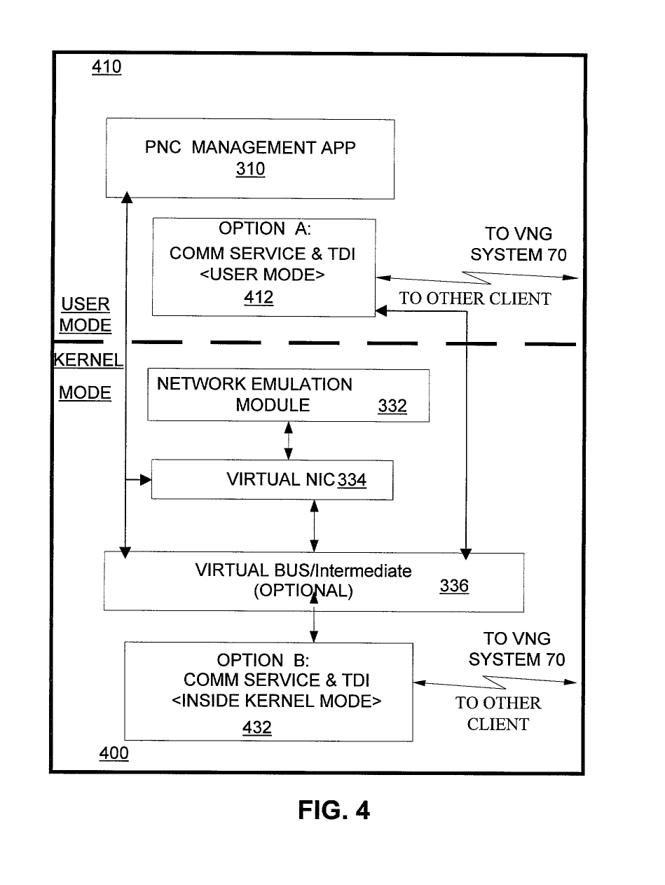

The network interface emulation module 332 is responsible for the network emulation achieved by mimicking the existence of a standard network segment environment and includes a virtual NIC driver 334 and, optionally, a host bus driver or intermediate driver 336. The virtual NIC driver 334 includes functionality for grabbing outgoing packets passed from an underlying host network driver interface system 420 (see FIG. 4) and for injecting received packets to the underlying host network driver interface system. There is no network card, per se, in the client. Rather, the virtual NIC driver 334 makes the host system access that such a card is actually installed and in fact allowing a standard modem to behave like a network card within the context of a LAN-like PNC. The virtual NIC driver 334 exports standard Ethernet, or any other LAN card protocol, functionality to it's host system. The virtual NIC driver 334 grabs outgoing and injects back incoming standard network protocol frames/packets native to the given electronic device (e.g., client 32 of FIG. 1C). These frames are set as payload/data of a PNC defined wrapper frame that is transmitted over the transit backbone.

The communication service module 338 in turn generates the wrapper frame and transmits the packet in accordance with standard related protocols (e.g., UDP, TCP/IP, HTTP), so that it can traverse any intermediate transit backbones, such as Internet, cable, or telephone. For incoming communications, the communication module 338 receives the data from the transit backbone (in it's standard protocol) unwraps each packet to be passed into the network emulation module 332. The communication service module 338 also processes received packets after they have been unwrapped in relation to security parameters, protocol authentication and optional compression/decompression. The communication service module 338 is responsible for the receiving and transmitting of all network data to and from the client host over the selected backbone.

PNC client backend service module 330 includes 3 basic elements:

1) Communication Service Management—As part of communication service module 338, a backend client host based service is set to control the provisioning of communications with the designated VNG server and with other clients that allow direct communication. This service is responsible for all data packets manipulation (e.g. wrapping, unwrapping, encryption, decryption, compression, decompression, frame packaging, etc.) and communication control.

2) Transport Data Interface (TDI)—Also as part of communication service module 338, a TDI is responsible for transmitting and receiving all data packets to and from the PNC client. The TDI includes functionality for the creation and manipulation of the communication channels so that the packet data can be transmitted and received over the existing physical connection to the backbone.

3) Virtual Network Interface Emulation Driver—As a sub-module to backend service module 330, a network emulation driver module 332 is include that is both a single and a dual driver based subsystem. In one form, a the virtual NIC driver module 334 of the network emulation module is set on the primary bus interacting with the communication service directly (i.e., single driver mode) or using an intermediate driver to encapsulate the communication service (i.e., dual driver mode). In another form, the virtual NIC driver 334 is set on a special dedicated virtual bus represented by a special dedicated bus driver (i.e., dual driver mode). The scope of responsibility of network emulation module 332 includes network card emulation packet grabbing and transfer to the communication service module 338, plus data packet reception from the communication service module 338 and injection into the host's network environment.

FIG. 4 depicts the PNC client backend service module 330 in two separate modes, a user plus kernel hybrid mode 410 and a kernel only mode 400. In the user plus kernel hybrid mode 410, the network emulation functionality of the backend services module 330 is set in a kernel mode (via the virtual NIC driver 334 and the optional bus/intermediate driver 336), but the actual communication service and TDI elements are set in user mode (via the communication service and TDI 412), which is indicated Option A 412. In the kernel only mode 400, the network emulation functionality of the backend services module 330, communication service and TDI are all set in kernel mode, which is indicated Option B 432. That is, as is shown in FIG. 4, the communication service and TDI modules may (in Option A, as 412) be operated in the user mode 410 or (in Option B, as 432) in the kernel mode 400. The PNC system bus or intermediate driver 336 is optionally included to represent a virtual bus.

All of the virtual NICs emulated by the supplied drivers can dynamically attach and detach themselves to and from the virtual bus in much the same way as a Universal Serial Bus (USB) device can be added or removed from a USB bus. The specialized bus driver approach (as opposed to latching on to the primary bus) allows for a more robust and flexible solution. The basic bus or intermediate driver functionality includes:

1) providing standard bus required services with emphasis on the adding and removing of PNC's virtual NIC(s) in the case of systems allowing for virtual bus generation and providing an abstraction layer for the virtual NIC(s) in the case of systems with no provisions for virtual bus generation;

2) providing and managing the pipeline between the PNC's virtual NIC(s) and the service and TDI modules; and

3) providing a control channel for managing the virtual NIC(s).

The basic TDI and communication service management functionality includes:

1) packet(s) data encryption/decryption;

2) packet(s) compression;

3) packet(s) caching;

4) packet(s) encapsulation (as data in a frame that can traverse the designated backbone);

5) client to VNG data tunnel management;

6) client to client(s) and vice versa tunnel management;

7) client's own incoming socket server handling (if client is allowed such access); and

8) optional spoofing of packets for protection against unwarranted operation and automatic loop back on packet traffic.

The basic PNC virtual NIC functionality includes:

1) providing standard network card services to the upper network layers;

2) emulating the existence of an actual network card;

3) passing packets received from the upper layers to the communication service management and TDI subsystems;

4) injecting packets received from the communication service management and TDI subsystem to the upper network layers; and

5) optional spoofing of packets for protection against unwarranted operation and automatic loop back on packet traffic.

Returning to FIG. 3, on the VNG system side, e.g., on VNG system 70 of FIG. 1C, a central management (CM) console module 370 is hosted on Web server 22 to facilitate access to a plurality of core modules 340 hosted on VNG data packet switch server 20. Web server 22 is standard Web server that exports a Web site (i.e., “front end”) responsible for facilitating the client to server management and control for registration, PNC workgroup creation, management, monitoring, log viewing, and billing access. CM console module 370 is a Web-based interface used for server install, update, management, alerts and general operation handling.

The network data packet switch server 20 of VNG system 70 is a high performance multi-user socket switch server used for connecting remote nodes (e.g., clients 32, 33, 34) according to their corresponding PNC workgroups (e.g., PNC-1). This switch server incorporates tunneling and software routing capabilities geared to close the connection loop for each different connection in the case of broadcast packets or in the case were direct client to client accessed is not available. The VNG system 70 exports the following major functionality:

1) initial logon;

2) user authentication;

3) protocol stack negotiation, according to the client's surrounding environment (direct connection to the Internet, via NAT, behind a firewall, using a proxy server);

4) downloading and updating the PNCs' information and access tables;

5) network packet routing to and from the different clients in cases were a client needs server assistance for communicating with another client (due to environmental or protocol restrictions) and the case of broadcast packets; and

6) optional security and key management.

Hosted behind the VNG web server 22 is a set of core components that provide a variety of system functionality including establishing and maintaining all network management policies, virtual addressing policies, host identification, security and key management, end-to-end management. In the preferred form, the core modules include a registration and authentication manager 342, a security manager 346, a PNC workgroup manager 350, and (optionally) a billing manager 360. Together with the data packet switch server 20, these elements establish and maintain a PNC having security, ease of use, privacy, throughput optimization, data compression and resource sharing.

The registration and authentication manager 342 allows a user (or a client in the case of a device not user operated, such as an application server) to establish an identity with the VNG system 70, generally. The registration and authentication is preferably conducted via the Web site interface managed and hosted on Web server 22, which may read and write directly from data storage device 24 or indirectly via server 70, or some combination thereof. The user inputs identification information that is stored in system database 24A, preferably in a user related account. An optional external user identification and authentication repository may be used provided an access proxy is made available (e.g. RADIUS server). Such an account may distinguish among users of different types, for example, wherein some users may have PNC setup privileges, while others may be only entitled to be a member of a PNC workgroup. It is necessary that each member be registered, so that each member can be uniquely identified within a PNC. To enter a PNC for which a user is registered, the user must authenticate with the VNG system. To authenticate, a user may be required to input a username and password. The registration and authentication manager 342 accepts the input and queries database 24A for corresponding identification information or, in another form, accesses an external authentication data source for corresponding identification. User registration and authentication is, in the preferred embodiment, a prerequisite to accomplishing the user's integration into a PNC, because the user's unique identity with the system is necessary for routing message traffic to that user within the corresponding PNC.

The security manager 346 provides data encryption information and key management services to allow the VNG system to provide pre-selected levels of security for each PNC created. The security parameters and levels are chosen as part of a user's setup of a PNC via the standard Web browser interface. The security manager 346 includes an encryption key generation and management module responsible for the creation and management of encryption keys for the different workgroups and client nodes, using known encryption techniques, such as public-private key pairs. Data carried on the public network backbone can be encrypted in different levels according to the setup defined per workgroup by its members. The actual encryption is performed by the corresponding clients themselves, “end-to-end”, so the data is rendered unreadable to eavesdroppers and in the case of private key scheme even to the server itself.

The server side packet switch server 20 provides the basic data packet processing and routing services of the VNG system in concert with the address and routing parameters held in the VNG server data repository. The packet switch server 20 establishes a connection loop for each PNC by allocating and binding the incoming communication channels into the different closed PNC(s) to which they belong. The packet switch server 20 provides the connection loop with the ability to support communication using common protocols (e.g., TCP/IP, UDP, HTTP) typically used in public communication infrastructures, by appropriately forwarding packets in accordance with those protocols. The packet switch server supplies the data connection loop for clients that cannot access each other directly, clients that need protocol translation in order to reach other client, and for broadcast packets. The protocols stacks supported by PNC clients and the VNG data switch server 20 have an underlying layer that can traverse the designated IP based backbone. In other words, the VNG data switch server protocol is set as the data of it's hosting standard protocol.

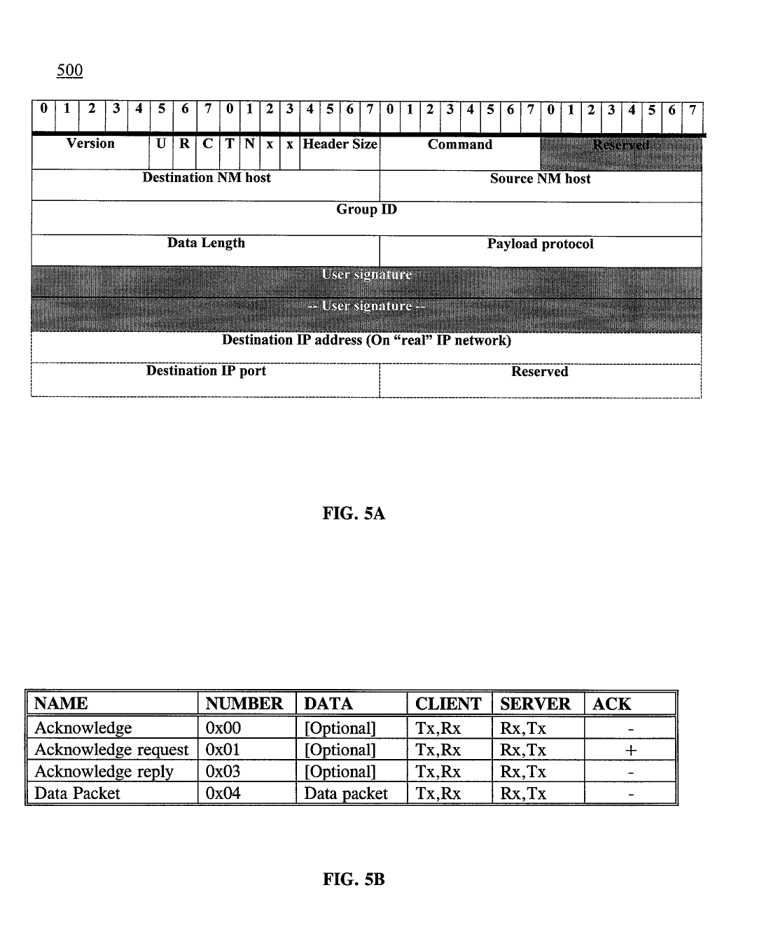

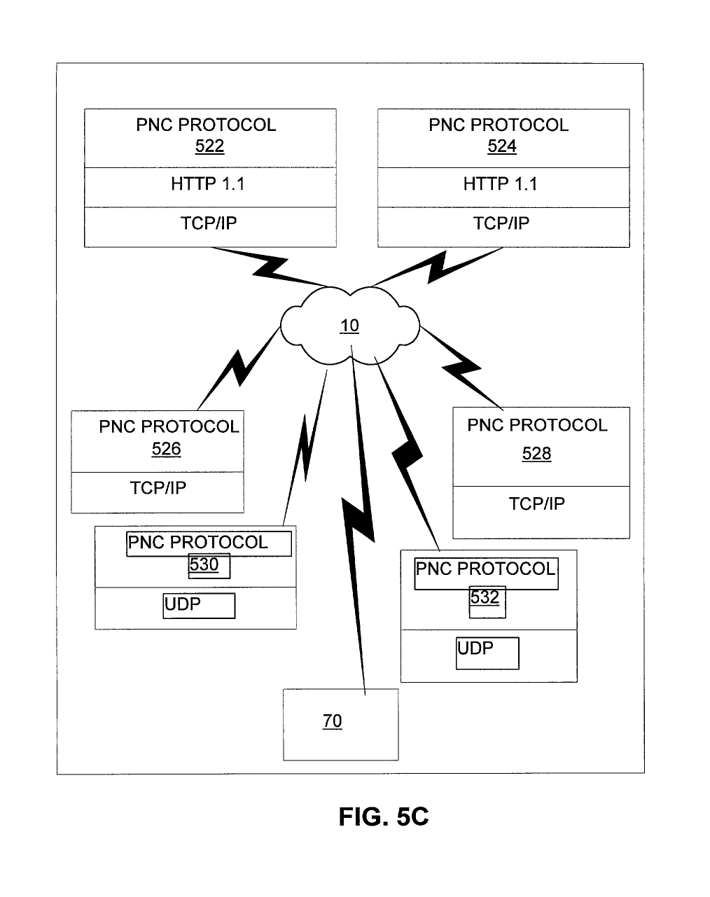

FIG. 5A shows a sample VNG data switch server protocol header definition 500 and FIG. The protocol stacks supported reflect the different client communication environment settings under witch the VNG system 70 protocol and implementation mechanism must operate. The following is a representative, although not exhaustive, list of environments under which a PNC client can persevere in the preferred embodiment:

1) direct standalone connection to the IP backbone (visible IP);

2) through a mediating NAT (Network Address Translator);

3) behind a firewall; and

4) using a proxy server.

Preferably, the VNG system 70 implements dynamic protocol stack handling in which each client identifies its surrounding environment and negotiates it's preferred input output protocol stacks with the VNG server 70. The protocol stacks selected remains for the duration of the current connection session. All incoming and outgoing PNC data packet related communications between the client and the data switch server or between the client and another client will conform to the given protocol stack selected. Each client node formats the data packet to be transmitted either according to it's own preferred protocol stack or, if possible, according to the designated recipient expected protocol stack. If the protocols stacks do not match then either the data switch server services for mediating are used (or the client takes the burden upon itself). Alternatively supported protocol stacks can be seen in FIG. 5C, clients 522, 524, 526, 528, 530, and 532.

A PNC manager 350 (see FIG. 3) serves as a system manager that provides general administration services, including orchestrating the other managers, performing system monitoring, generating usage information, and facilitating PNC setup. For example, the PNC manager 350 receives information regarding a new PNC and tasks the other managers to perform authentication, address generation and assignment, implement selected security levels, and so on. For each PNC, a PNC session manager is created as an extension of the PNC manager 350 to perform administration of the PNC during operation. The PNC manager also performs termination of a PNC upon realization of a termination event (e.g., expiration, tasks complete, security violation, user request, etc.).

As an optional feature, the VNG system may include billing manager 360 (see FIG. 3). Billing manager 360 is an interface stub, preferably executed on server 20, that enables the generation of billing information from logged usage data stored in the account database 24B. In such an embodiment, usage information is logged, for example, on a time, number of users, or some other basis. The billing module 360 derives billing information from the usage information and generates corresponding invoices therefrom. Additionally, the billing module 360 may perform electronic fund transfers to effect payment of such invoices.

The PNC is initially established by a user (e.g., in FIG. 1C, User 1 may setup PNC-1) on the VNG system 70, which includes defining a set of clients to be included in the PNC and defining other PNC attributes (e.g., security). In the preferred form, the users use the web server 22 as the command channel and a combination of direct communication (if possible) and the data switch server 20 as the data channel. Once a PNC is established, the end-to-end communication among devices takes place either within a connection loop supplied by the data switch server 20 or directly or a combination of the two. After setup, the designated users connect through the backbone and join PNC-1 using their corresponding clients 32, 33 and 34. PNC-1 users 33 and 34 can, at any point in PNC-1's existence, send information to shared resources, such as printer 31, connected physically only to user's 32 device. In a similar fashion, other clients, such as clients 41 and 42, establish a separate PNC referred to as PNC-2 40, while clients 51 and 52 establish a PNC referred to as PNC-3 50, all through the same backbone 10. Notice that VNG system 70 allows PNCs 40 and 50 to communicate between themselves, by mutual demand and with shared security, as an example.

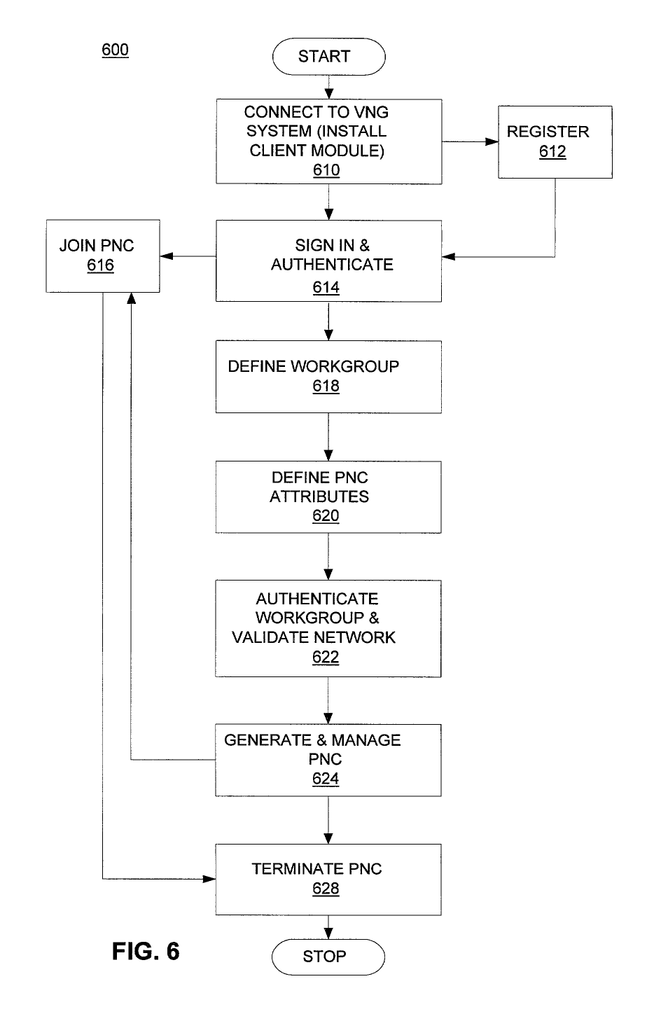

A preferred sequence of steps for the method of establishing a PNC in accordance with the present invention, may be appreciated with respect to FIG. 6. In the preferred form, in step 610, a user, e.g., User-1 32, registers on a VNG system 70, via a front-end server, such as Web server 22, and a shared backbone 10 (e.g., the Internet). The user downloads and installs a host dependant agent (i.e., PNC Client 210) from the Web site of VNG system 70. Alternatively, the user turns on a client with a PNC client already installed, which may be set active upon boot. The VNG web server 22 provides general directory like information on network communities made available for public use through the Web server's Web site interface. In step 612, User-1 signs in with the VNG system and activates the installed client module 310, if the user has not already done so in a previous session. Alternatively, the user may be automatically signed in to the VNG system 70 upon boot, depending on the configuration of the PNC client. The user then is authenticates with the VNG system 70, in step 614, and is granted access to a corresponding PNC or may setup a new PNC. That is, through the PNC client module, a user can create, delete, manage, and monitor its own PNC or join a previously created PNC in step 616, provided the user is authorized to do so. The PNC client module preferably provides an intuitive wizard driven interface for administrative control over a PNC workgroup being defined during setup, including handling the different attributed security level, availability schedule, permissions and connection topology.

Assuming that the user is setting up a new PNC, the user establishes the various PNC workgroup membership (i.e., users and other resources), in step 618, and VNG attributes TO (e.g., address resolution definition, security management, communication attributes, task descriptions, or termination event requirements), in step 620, necessary for establishing the PNC. Upon receipt of the user's PNC setup request, the system database (e.g., database 24A is accessed), which holds all information related to different users and networks the VNG system manages, the PNC workgroup is authenticated, and the requested network is validated, in step 622.

In step 624, the VNG system establishes the PNC, by for example allocating a unique PNC address to each PNC workgroup member, creating a PNC session manager enabled to facilitate formation of the connection loop and implementation of the requested PNC security measures, in step 622. In step 616, the workgroup logs into the PNC and, for example, performs a desired set of tasks. Once selecting and activating a given PNC, or having one automatically booted up, the user can assume standard LAN-like network flows between all the nodes activated and connected. For example in the case of PC nodes, users can take advantage of shared files/folders/application/printers, or any other network resources for that matter. Upon some termination event, e.g., completion of tasks, time out, security violation, and so on, disassembly of the PNC occurs, in step 628.

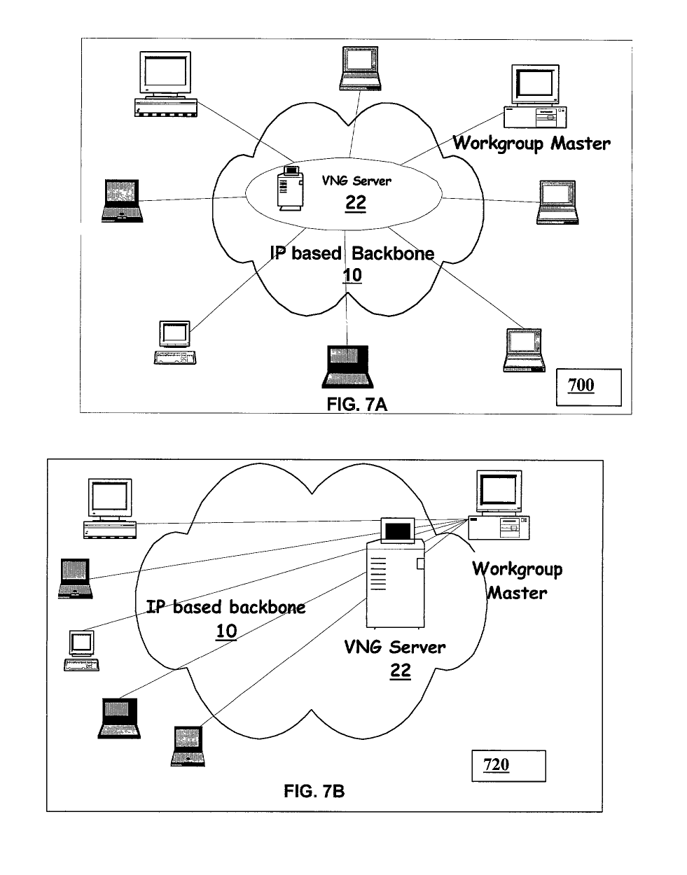

In the preferred form, the VNG system supports at least two basic network topologies. The first topology is a “mesh” topology 700 shown in FIG. 7A, where all connected workgroup subscribers can identify and collaborate with each other (similar to an office LAN workgroup connection). The second topology is a “star” topology 720, shown in FIG. 7B, wherein subscribers can only see the network master (PNC creator) and not each other. These topologies are generally known in the art, so not discussed in detail here.

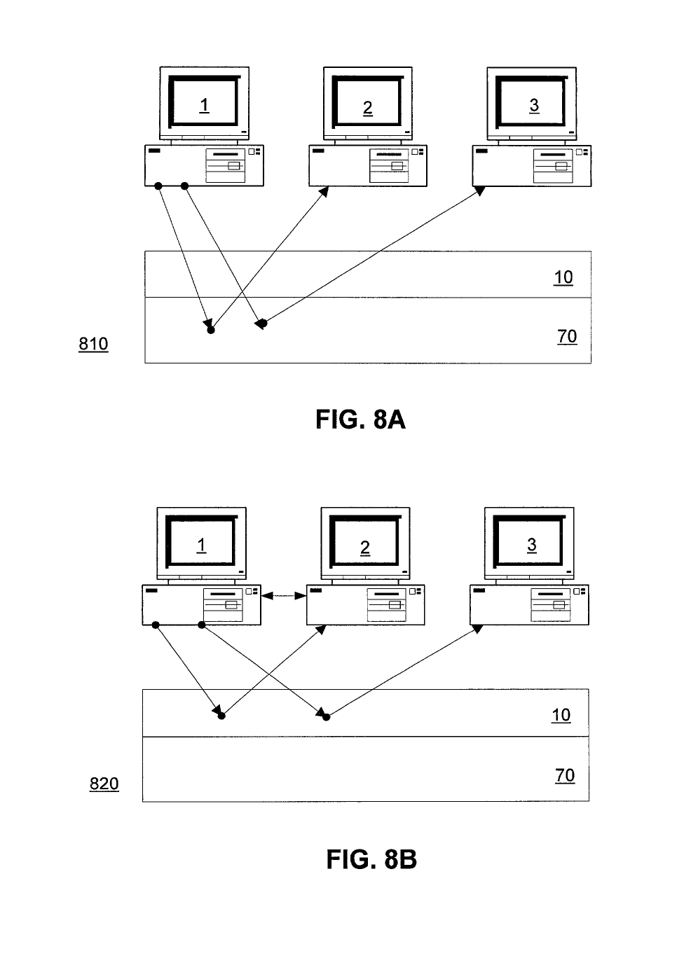

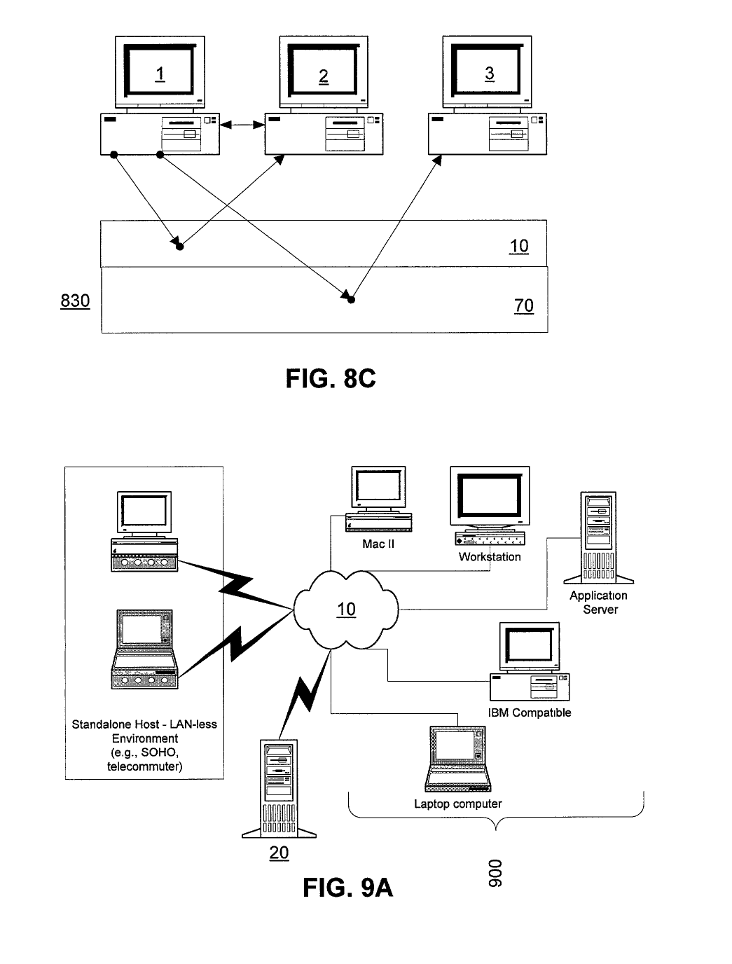

In the preferred form, the VNG system facilitates the establishment of PNCs that support at least three basic network communication schemes, as depicted in FIGS. 8A-8C. These schemes include “always-via-server”, “client-to-client”, and “mixed”, respectively. In the always-via-server topology 810, in FIG. 8A, all data always flows from the client to a selected server (e.g., VNG server 20 of VNG system 70). The VNG server 20 re-routes the data to the destination(s). Under this topology the VNG server 20 serves as a software switch. In the client-to-client topology 820, in FIG. 8B, the VNG server 20 handles the initial handshake: logon, authentication, security key exchange, and network information table updates. The VNG server is only responsible for the network broadcast data re-routing. Data packets destined for a specific mapped client (i.e., none broadcast) are sent directly (client to client) with no server intervention. Finally, a mixed topology 830, in FIG. 8C, is an adaptive combination of the above mentioned topologies, according to environmental limitations (such as: backbone limitation, firewall restrictions, proxy issues) or best latency calculation (in which the via server route is faster).

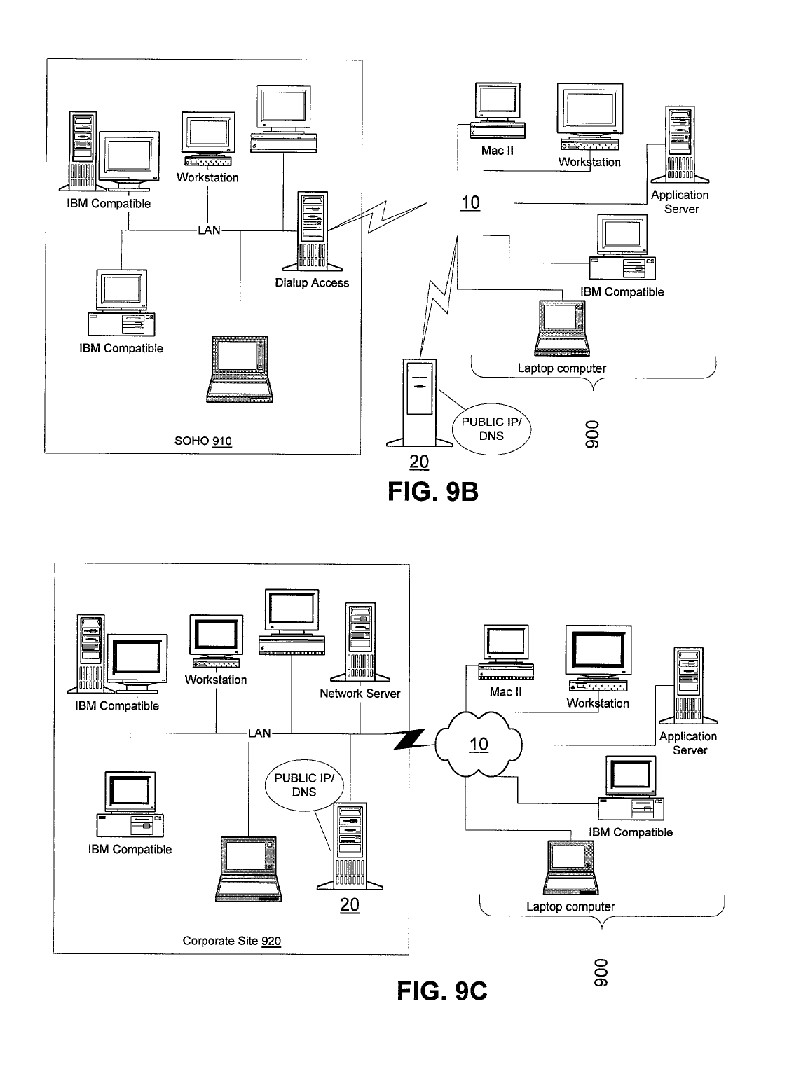

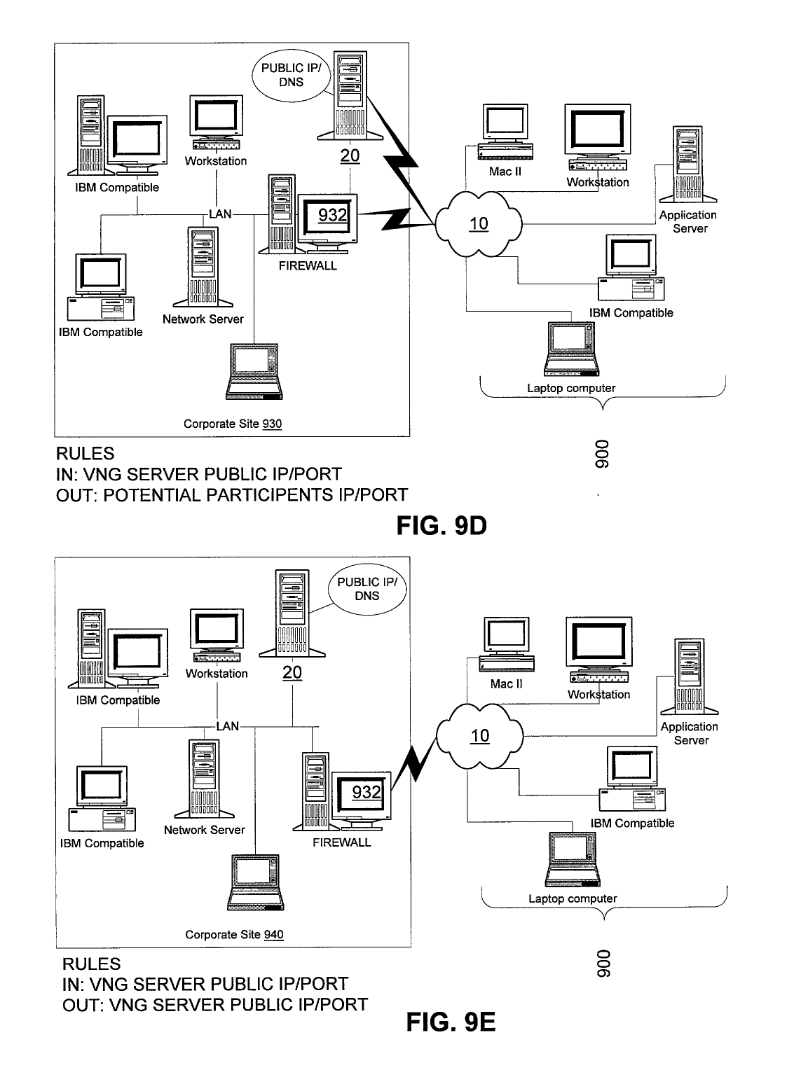

In the preferred form, the VNG server 20 may be “hooked up” in any of a variety of configurations or scenarios, as indicated by the examples in FIGS. 9A-E. In FIG. 9A, VNG server 20 is configured as a standalone server accessible by a plurality of standalone clients 900 via a commonly available communication network 10, e.g., the Internet. In FIG. 9B, VNG server 20 is configured as a standalone server accessible by a plurality of networked devices 910 and standalone clients 900 via a commonly available communication network 10, e.g., the Internet. In FIG. 9C, VNG server 20 is configured as a LAN-Add On, i.e., hangs off of an established LAN, as part of architecture 920, wherein there is no firewall between the LAN and cloud 10. As before, clients 900 can also access VNG server 20 via cloud 10. The architecture 930 of FIG. 9D is similar to architecture 920 of FIG. 9C, in that VNG server 70 is still a LAN-Add On. However, in FIG. 9D, a firewall system 932 is included between VNG server 20 and the other LAN components. The architecture 940 of FIG. 9E is similar to architecture 930 of FIG. 9D, however, in FIG. 9E VNG server 20 is a LAN-Add On located inside the firewall 932.

The invention may be embodied in other specific forms without departing from the spirit or central characteristics thereof. The present embodiments are therefore to be considered in all respects as illustrative and not restrictive, the scope of the invention being indicated by appending claims rather than by the foregoing description, and all changes that come within the meaning and range of equivalency of the claims are therefore intended to be embraced therein.

What is claimed:

1. A method of establishing a private network community (PNC) among a plurality of clients configured to be linked over one or more of a plurality of communication channels, said method comprising:
A. linking to a virtual network generation (VNG) system, having access to said communication channels, and establishing a set of PNC attributes, including establishing a set of client attributes associated with said clients and a set of network attributes;
B. accessing a VNG system data store including PNC information related to said plurality of clients and a plurality of network types;
C. authenticating each of said clients, as a function of said PNC information; and
D. establishing said PNC as a function of said set of PNC attributes, including designating a virtual PNC address for each of said clients and linking said clients as if they were connected via a LAN.

2. The method according to claim 1 wherein said plurality of clients is operated by a corresponding plurality of users and said data store includes identification information related to said plurality of users.

3. The method according to claim 1 wherein at least one of said plurality of clients is chosen from a group of network enabled devices comprising:
1) a personal computer;
2) a personal digital assistant;
3) a mobile cellular telephone;
4) a network appliance;
5) a digitally loadable music or video player;
6) an on-line video game; and
7) a home appliance.

4. The method according to claim 1 wherein at least one of said plurality of communication channels is chosen from a group comprising:
1) Internet;
2) a cable network;
3) metropolitan area networks (MAN);
4) a power-line network;
5) a telephone line;
6) a satellite link; and
7) wireless networks.

5. The method according to claim 1 wherein said client attributes include, for each client:
1) an identification attribute, identifying said client; and
2) a PNC address attribute, identifying a network location of said client.

6. The method according to claim 1 wherein said network attributes include:
1) a security management attribute, identifying a network security level to which said PNC must adhere.

7. The method of claim 1 further comprising:
E. selectively disestablishing said PNC in response to a termination event.

8. The method according to claim 7 wherein step E includes:
1) disassociating each of said designated addresses from said clients.

9. The method according to claim 7 wherein said termination event includes one of more of the following:
1) issuing a termination command by at least one of said clients to said VNG system;
2) detecting completion of a predefined set of tasks;
3) detecting a security violation; and
4) lapsing of a termination point in time.

10. The method according to claim 1 further comprising:
E. modifying said PNC attributes; and
F. modifying said client links as a function of said modified PNC attributes.

11. The method of claim 1, further comprising:
E. sending a packet across said PNC, from a first client to a second client, wherein said sending said packet includes:
1) grabbing a packet destined for the virtual network card;
2) identifying said packet;
3) wrapping said packet in a wrapper frame by said first client;
4) transmitting said packet from said first client and receiving said packet by said second client;
5) unwrapping said packet by said second client, and
6) injecting said packet into a networking driver interface system of said second client, as if said packet was received by a standard network card of said second client.

12. The method of claim 11 wherein sub-step 4) includes:
a) sending said packet to a VNG server of said VNG system; and
b) forwarding said packet by said VNG server to a set of destinations clients, including said second client, associated with said packet.

13. The method of claim 12, wherein said first client implements a first protocol and said second client implements a second protocol, and wherein sub-step 3 includes wrapping said packet in a frame compatible with said first protocol and sub-step b) includes:
i. unwrapping said packet; and
ii. re-wrapping said packet in a frame that is compatible with said second protocol.
iii. transmitting said re-wrapped packet to said second client.

14. The method of claim 11, wherein sub-step 3) includes compressing said message according to said network attributes and sub-step 5) includes decompressing of said message.

15. The method of claim 11, wherein sub-step 3) includes encrypting said message according to said network attributes and sub-step 5) includes decrypting said message.

16. The method of claim 1, wherein said VNG system includes a billing manager, said method further comprising:
E. monitoring usage of said PNC by said plurality of devices and generating, as a function of said usage, a corresponding usage bill.

17. The method of claim 1 wherein step B includes:
1) accessing a VNG system Web site.

18. A virtual network generation (VNG) system configured to establish and manage a plurality of PNCs among a plurality of clients and over a plurality of communication channels, said VNG system comprising:
A. a data store including PNC information related to said clients and a plurality of network types;
B. a VNG processing device coupled to said data store, said VNG processing device including:
1) an authentication manager, configured to receive, store and selectively authenticate a PNC workgroup of clients from said plurality of clients, as a function of a client identification;
2) a PNC manager, configured to receive and store a set of PNC attributes related to a PNC to be established, wherein said PNC attributes identify the PNC workgroup and a set of PNC security requirements;
3) a PNC routing manager, configured to generate a PNC address for each client; and
4) a communication manager, configured to link said clients, as if they were connected via a LAN, as a function of said PNC attributes; and
C. a network interface system coupling said VNG processing device to at least one of said plurality of communication channels.

19. A VNG system according to claim 18, further comprising:
D. a PNC termination manager, configured to selectively terminate said PNC in response to a termination event.

20. A VNG system according to claim 19 wherein said termination manager is configured to disassociate each of said designated addresses from said clients.

21. A VNG system according to claim 19 wherein said termination event includes at least one of the following:
1) issuing a termination command by at least one of said clients to said VNG system;
2) detecting completion of a predefined set of tasks;
3) detecting a security violation; and
4) lapsing of a termination point in time.

22. A VNG system according to claim 18 wherein said plurality of clients is operated by a corresponding plurality of users and said data store includes identification information related to said plurality of users.

23. A VNG system according to claim 18 wherein at least one of said plurality of clients is chosen from a group of network enabled devices comprising:
1) a personal computer;
2) a personal digital assistant;
3) a mobile cellular telephone;
4) a network appliance;
5) a digitally loadable music or video player;
6) an on-line video game; and
7) a home appliance.

24. A VNG system according to claim 18 wherein at least one of said plurality of communication channels is chosen from a group comprising:
1) Internet;
2) a cable network;
3) metropolitan area networks (MAN);
4) a power-line network;
5) a telephone line;
6) a satellite link; and
7) wireless networks.

25. A VNG system according to claim 18 wherein said client attributes include, for each client:
1) an identification attribute, identifying said client; and
2) a PNC address attribute, identifying a network location of said client.

26. A VNG system according to claim 18, further including:
D. a front end VNG system Web site.

27. A VNG system according to claim 18 wherein said network attributes include:
1) a security management attribute, identifying a network security level to which said PNC must adhere.

28. A VNG system according to claim 18 wherein said PNC manager includes configured to:
a) PNC attribute modifier; and
b) PNC client link modifier, configured to modify said client links as a function of a set of modified PNC attributes.

29. A VNG system according to claim 18, wherein each client in said PNC includes:
D. a client module configured to wrap packets to be transmitted in a wrapper frame, wherein said wrapper frame is compatible with at least one of said plurality of communication channels and a corresponding communication protocol.

30. A VNG system according to claim 18, wherein message traffic within said PNC is encrypted.

31. A VNG system according to claim 18, wherein said VNG processing device further includes
5) a usage monitor configured to monitor usage of said PNC by said plurality of clients and generate corresponding usage information; and
6) a billing manager, configured to generate a corresponding invoice, as a function of said usage information.
